(19) United States
(12) Patent Application Publication
(10) Pub. No.: US 2009/0328218 A1
(43) Pub. Date: Dec. 31, 2009

(54) DATA PROCESSING SYSTEM, DATA PROCESSING METHOD, AND PROGRAM

(75) Inventor: Tatsuya Tsurukawa, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Chiyoda-ku (JP)

(21) Appl. No.: 12/374,821

(22) PCT Filed: Aug. 28, 2006
(86) PCT No.: PCT/JP2006/316847

§ 371 Date: Jan. 23, 2009

(51) Int. Cl. G06F 12/14; G06F 12/00; G06F 12/16

(52) U.S. Cl. 726/23; 711/216; 711/162; 711/E12.001; 711/E12.103; 711/E12.093

(57) ABSTRACT

A log output device and a program are provided, which append a signature to a log, prevent an undetectable tampering (alteration, insertion, deletion, etc.), and are able to narrow tampered position if tampered. The log output device forms a log record including a data part and a hash part, and outputs to a disk; the hash part is formed by combining a hash of the data part (data hash) and a hash of the hash part of the previous record (link hash); a signature is appended to only a part of records of a hash chain; when outputting the record to the disk, a copy of the hash part of the record is maintained on a process memory; when outputting next record, the hash part of the latest record on the disk and the hash part maintained on the process memory are compared; if they are matched, the record on the disk is determined as not being tampered, and if mismatched, the record is determined as tampered.

### TECHNICAL FIELD

The present invention relates to, for example, a log in a contents distribution system or a company information system, and in particular, to technique to prevent undetectable tampering (alteration, wrong record insertion, deletion, etc.) and to secure integrity of the log by appending a signature to log data.

### BACKGROUND ART

Nowadays, a “log” outputted from equipments or devices belonging to a system has increased its importance in a contents distribution system or a company information system.

For example, in the contents distribution system, it has been carried out or will be carried out that the contents holder verifies whether sales of the contents is done within a licensed range (permitted sales amount, sales price, etc.) permitted for the contents provider (distributor) by the contents holder based on a log of the contents distribution system deployed and developed by the contents provider.

Further, it has been carried out or will be carried out that a studio verifies whether a movie is screened within a range (permitted screening period, screening times) permitted by the studio which supplies a digital movie to a movie theater based on a log of a movie theater system.

On the other hand, in the company information system, the log has been used, when a security issue occurs such as information compromise of a customer list or company secret, for seeking the cause of the issue by analyzing logs collected from the system and stored, and for a purpose such as inspection to show objectively that the information system is properly operated.

Like this, since the log has been playing an important role in all systems nowadays, tampering of log data is a large threat for employing the system, and it has been an important problem to secure the integrity (to certify that it is not tampered) of the log.

Under this background, two main approaches are proposed to secure the integrity of the log:
1. to prevent the tampering itself of the log
2. when the log is tampered, to be able to certainly detect the tampering

Of these, the main object of the invention explained in this specification is the above 2. Further, conventional art having the same object will be explained in the following.

For example, the Patent Document 1 discloses a data storage processing method for storing data by appending a hash/signature for each piece of data generated time-sequentially such as an access log. At that time, a hash chain is configured by obtaining a hash from data composed of the corresponding data and the previous data and appending a signature to the hash.

However, according to this prior art, the signature is appended to each of all the records. Since the signature process (secret key operation) requires a large quantity of calculation (approximate 100-1000 times of hash calculation), the processing load becomes very high under circumstance that record is frequently generated, which causes a problem that this prior art is not practical. Further, since the signature is appended to each record, there is another problem that the whole size of data becomes large (if RSA (registered trademark) (Rivest Shamir Adleman) 2048-bit key is used for the signature, the data size is increased by 256 bytes per record; namely, about 342 bytes if Base 64 transformation is carried out).

On the other hand, the Non-Patent Document 1 also discloses/suggests a configuration using a hash chain for appending the signature to the log. This prior art discloses a configuration drawing in which the signature is appended to only the last hash of the hash chain. Although it refers to possibility to reduce the signature load or the log size, concrete implementing method is never shown at what timing to append the signature to the log data, which dynamically changes, and how to protect data, which is not protected by the signature, from undetectable tampering. Thus, it is not possible to concretely obtain the advantage of the idea.

Further, the Patent Document 2 discloses an idea for detecting tampering of data by dividing signature target data, which is not a log, calculating respective hashes, forming a hierarchical structure of them, and appending a signature to the hash of the uppermost level.

However, according to this prior art, the signature is appended only at the final stage after some amount of logs are accumulated, so that there is a problem that it is impossible to find a tampering if the data is tampered before the logs are accumulated to reach the some amount (because of character of data such as a log, it is necessary to always append a signature instead of appending only at the final stage).

### Patent Document 1: JP2003-143139

### Patent Document 2: JP2001-519930

Non-patent Document 1: Digital Cinema System Specification V1.0 p. 116-117, Jul. 20, 2005 Digital Cinema Initiatives, LLC, http://www.dcimovies.com/

### DISCLOSURE OF THE INVENTION

### Problems to be Solved by the Invention

A main object of the present invention is to solve the above problems, and further another main object is to obtain a data processing system, a data processing method, and its program having a function, when data is tampered, to not only detect tampering but also narrow the tampered position as narrow as possible.

### Means to Solve the Problems

According to the present invention, a data processing system using a first memory device and a second memory device, appending a hash value to data which is sequentially outputted, and storing the data to which the hash value is appended in the second memory device, the data processing system includes:
a hash value copying and storing unit, at each time of storing the data in the second memory device, for copying a first hash value and a second hash value which are appended to storage data to be stored in the second memory device, the first hash value being generated from the storage data, the second hash value being generated from a hash value of data which has been stored prior to the storage data, and storing a copy of the first hash value and the second hash value in the first memory device;
a hash value comparing unit, when new data is outputted, for comparing a last first hash value and a last second hash value appended to last data stored last in the second memory unit with a copy of the last first hash value and the last second hash value stored in the first memory device;
a hash value generating unit, when the hash value comparing unit determines that the last first hash value and the last second hash value and the copy of the last first hash value and the last second hash value are matched, for generating a new first hash value from the new data, and generating a new second hash value from the last first hash value and the last second hash value; and
a data storing unit for appending the new first hash value and the new second hash value generated by the hash value generating unit to the new data, and storing the new data to which the new first hash value and the new second hash value are appended in the second memory device.

The hash value generating unit, when the hash value comparing unit determines that the last first hash value and the last second hash value and the copy of the last first hash value and the last second hash value are mismatched, generates the new first hash value from the new data, and generates the new second hash value from a value other than the last first hash value and the last second hash value.

The data processing system further includes:
a tampering detecting report generating unit, when the hash value comparing unit determines that the last first hash value and the last second hash value and the copy of the last first hash value and the last second hash value are mismatched, for generating a tampering detecting report to notify of a tampering in the last data.

The hash value copying and storing unit stores the copy of the first hash value and the second hash value in a tamper proof device as the first memory device.

The data processing system further includes:
a signature generating unit for generating a signature for a specific piece of data among a plurality pieces of data, and appending the generated signature to only the specific piece of data.

The signature generating unit generates the signature at every certain interval of data.

The signature generating unit generates the signature at every certain interval of time.

The signature generating unit generates the signature based on an instruction from an application program which uses the data processing system.

The signature generating unit generates the signature when a transfer request of data stored in the second memory device is issued from outside of the data processing system.

The signature generating unit generates the signature based on an instruction from a user who uses the data processing system.

The signature generating unit generates the signature when an IDS (Intrusion Detection System)/IPS (Intrusion Prevention System) of the data processing system detects unauthorized intrusion.

The signature generating unit generates the signature for data outputted last, when the data processing system finishes operation.

The data processing system further includes:
a data checking unit, when the data processing system starts, for checking data stored in the second memory device, and if there exists data stored after last data to which a signature is appended, generating an alert to notify of existence of the data stored after the last data to which the signature is appended.

The hash value generating unit generates upper level hash values from a plurality of first hash values, generates further upper level hash values from a plurality of upper level hash values, and generates upper level hash values over a plurality of hierarchies.

The data processing system further includes:
a signature generating unit for generating a signature using a hash value of an uppermost level among upper level hash values generated by the hash value generating unit.

According to the present invention, a data processing method using a first memory device and a second memory device, appending a hash value to data which is sequentially outputted, and storing the data to which the hash value is appended in the second memory device, the method includes:
at each time of storing the data in the second memory device, copying a first hash value and a second hash value which are appended to storage data to be stored in the second memory device, the first hash value being generated from the storage data, the second hash value being generated from a hash value of data which has been stored prior to the storage data, and storing a copy of the first hash value and the second hash value in the first memory device;
when new data is outputted, comparing a last first hash value and a last second hash value appended to last data stored last in the second memory unit with a copy of the last first hash value and the last second hash value stored in the first memory device;
when it is determined that the last first hash value and the last second hash value and the copy of the last first hash value and the last second hash value are matched, for generating a new first hash value from the new data, and generating a new second hash value from the last first hash value and the last second hash value; and
appending the new first hash value and the new second hash value generated to the new data, and storing the new data to which the new first hash value and the new second hash value are appended in the second memory device.

According to the present invention, a program for making a computer having a first memory device and a second memory device append a hash value to data which is sequentially outputted, and store the data to which the hash value is appended in the second memory device, the program makes the computer execute:
a hash value copying and storing process, at each time of storing the data in the second memory device, for copying a first hash value and a second hash value which are appended to storage data to be stored in the second memory device, the first hash value being generated from the storage data, the second hash value being generated from a hash value of data which has been stored prior to the storage data, and storing a copy of the first hash value and the second hash value in the first memory device;
a hash values comparing process, when new data is outputted, for comparing a last first hash value and a last second hash value appended to last data stored last in the second memory unit with a copy of the last first hash value and the last second hash value stored in the first memory device;
a hash value generating process, when the hash value comparing process determines that the last first hash value and the last second hash value and the copy of the last first hash value and the last second hash value are matched, for generating a new first hash value from the new data, and generating a new second hash value from the last first hash value and the last second hash value; and
a data storing process for appending the new first hash value and the new second hash value generated by the hash value generating process to the new data, and storing the new data to which the new first hash value and the new second hash value are appended in the second memory device.

### Effect of the Invention

As discussed above, according to the present invention, by storing in the first memory device a copy of the first hash value and the second hash value of storage data to be stored in the second memory device, and when new data is outputted, by comparing the last first hash value and the last second hash value stored in the second memory device with the copy of the last first hash value and the last second hash value stored in the first memory device, it is possible to detect tampering, so that it becomes unnecessary to append a signature to all data to be stored in the second memory device, which reduces the load of signature process and prevents increase of data amount because of the signatures.

Further, in addition to solving the problems of the conventional art, the present invention brings effect to have a function to prevent undetectable tampering, and when tampered, to narrow a possibly tampered position as narrow as possible.

### PREFERRED EMBODIMENTS FOR CARRYING OUT THE INVENTION

### Embodiment 1

### (Basic Configurations of a Log Output Device and a Log Output Program and Signature Appendage at Every Certain Number of Lines Interval and at Every Certain Time Interval)

(Format of a Log and Formation of a Hash Chain)

FIG. 1 is a block diagram showing a format of a log for a log output device according to the first embodiment.

A disk 1 records/stores a log.

A record 10 (or simply record, hereinafter) is formed by a data part 11 and a hash part 12. Here the data part 11 is a log message body.

Further, the hash part 12 is formed by a data hash (DH) 13 which is a hash value of the data part 11, and a link hash (LH) 14 which is a further hash value of the hash part 12 of the previous record 10 (here, for the initial record, it is assumed that the hash of the data hash is the link hash).

The data hash (DH) 13 is an example of the first hash value, and the link hash (LH) 14 is an example of the second hash value.

A signed record 20 is a record formed by calculating a signature of the hash part 12 of the record 10 and appending the signature after the hash part 12 as a signature (SIG) 15.

A signature block 1 (2) and a signature block 2 (3) are groups of records connected with a group of links of the link hash (LH) 14 (hash chain) from the initial record to the signed record 20. The final block N (4) shows unsigned status, to which a signature has not yet appended.

Further, the hash chain is connected among blocks. In FIG. 1, the link hash (LH) 14 of the initial record of the signature block 2 (3) is concatenated to the hash part 12 of the final record.

If the log generated as above is transferred to another system, by sending the log with status in which the signature is appended to the latest record so as to verify the integrity (being not tampered) by the transferred designation, it is possible to send a plurality of signature blocks at once.

By forming the log as discussed above, a part which is given a signature is the hash part 12 of the final record, which brings an advantage that it is unnecessary to read the whole log so as to calculate a hash when appending the signature.

(Configuration Example of the Log Output Device)

FIG. 2 is a block diagram showing a configuration example of the log output device according to the first embodiment of the present invention.

It is assumed that the log output device 100 is a general computer including a CPU (Central Processing Unit), a memory, a disk, an inputting device such as a keyboard/mouse, and an outputting device such as a display.

The log output device 100 includes a log output processing unit 101. The log output processing unit 101 is an example of a data processing system. The log output processing unit 101 can be implemented by, for example, a log outputting resident program which is resident in a memory.

The log output processing unit 101 receives a log outputted by various application programs 111 (or simply applications, hereinafter) via a log output library 110 to which each application program links, for example, through interprocess communication, and outputs the log with a signature to a disk 112.

Further, the log output device 100 includes a latest hash memory unit 102. The latest hash memory unit 102 can be implemented by, for example, allocating a memory area for storing the latest hash value on a process memory.

The latest hash memory unit 102 is formed to maintain a copy of the hash part 12 (both of the data hash (DH) 13 and the link hash (LH) 14) of the latest record outputted to the disk 112 as the log.

The latest hash memory unit 102 (a process memory) is an example of the first memory device, and the disk 112 is an example of the second memory device.

Further, the log output device 100 includes a signature requesting unit 103. The signature requesting unit 103 receives a signature request from an outside or an inside of the log output device 100, and outputs the signature request to a signature generating unit 1013 (discussed later) inside of the log output processing unit 101, and then the signature is appended to the latest record of the log on the disk 112.

The signature requesting unit 103, concretely, can be implemented by a mechanism such as a signal handler in the UNIX (registered trademark) program, and it is also possible to implement by an explicit signature request from the log output library 110, or by maintaining a timer to give a timing for generating a signature by itself, etc.

The log output device 100 holds a pair of public keys by itself, respectively maintained in a secret key maintaining unit 104 and a public key maintaining unit 105. Further, a tamper proof device 106 can be included optionally; in such a case, the log output device 100 can be formed to include the latest hash memory unit 102 and the secret key maintaining unit 104 in the tamper proof device 106.

Next, FIG. 3 explains an internal configuration example of the log output processing unit 101 (the data processing system).

Each time a record is stored in the disk 112 (the second memory device), a hash value copying and storing unit 1015 copies the data hash (DH) 13 (the first hash value), which is generated from the data part 11 of the corresponding record and appended to the record to be stored, and the link hash (LH) 14 (the second hash value), which is generated from the hash part 12 which has been stored prior to the corresponding record, and stores the copy of the data hash (DH) 13 and the link hash (LH) 14 in the latest hash memory unit 102 (the first memory device).

When new data (the data part 11) is outputted, a hash value comparing unit 1011 compares the last hash part 12 (the data hash (DH) 13 and the link hash (LH) 14) appended to the last data which is stored in the disk 112 the last with the copy of the last hash part 12 stored in the latest hash memory unit 102.

If the hash value comparing unit 1011 determines that the last hash part 12 and the copy of the last hash part 12 are matched, a hash value generating unit 1012 generates a new data hash (DH) 13 from new data (the data part 11) and as well generates a new link hash (LH) 14 from the last hash part 12.

Based on the signature request from the signature requesting unit 103, the signature generating unit 1013 generates a signature for specific piece of data (the last data) among plural pieces of data and appends the generated signature to the specific data. The signature generating unit 1013 can generate a signature, for example, at every certain data interval or can generate a signature at every certain time interval.

A data storing unit 1014 appends the new data hash (DH) 13 and the new link hash (LH) 14 generated by the hash value generating unit 1012 to the new data (the data part 11) as the hash part 12, and stores the record 10 in the disk 112 (the second memory device) after the data hash (DH) 13 and the link hash (LH) 14 are appended.

Further, if the signature is generated by the signature generating unit 1013, the data storing unit 1014 stores the signed record 20 to which the signature is appended in the disk 112.

A tampering detecting report generating unit 1016 generates a tampering detecting report to notify of tampering at the last data if the hash value comparing unit 1011 determines that the last hash part 12 and the copy of the last hash part 12 are mismatched.

Here, when the hash value comparing unit 1011 determines the last hash part 12 and the copy of the last hash part 12 are mismatched, as well as the generation of the tampering detecting report by the tampering detecting report generating unit 1016, the hash value generating unit 1012 can generate a new data hash (DH) 13 from new data, and as well generate a new link hash (LH) 14 from a value other than the last hash part 12. In this case, the new data is not to be linked to the last data which has been tampered.

(Hardware Configuration Example of the Log Output Device)

Next, a hardware configuration example of the log output device 100 including the log output processing unit 101 will be explained.

As has been discussed, the log output device 100 can be formed by a general computer; it can be formed by, for example, a hardware configuration shown in FIG. 10.

Here, the configuration of FIG. 10 merely shows an example of the hardware configuration of the log output device 100; the hardware configuration of the log output device 100 is not limited to the configuration shown in FIG. 10, but can be another configuration.

In FIG. 10, the log output device 100 includes a CPU 911 (Central Processing Unit; also called a central processing device, a processing device, an operation device, a micro processor, a micro computer, or a processor) which executes programs.

The CPU 911 is connected via a bus 912 to, for example, a ROM (Read Only Memory) 913, a RAM (Random Access Memory) 914, a communication board 915, a display unit 901, a keyboard 902, a mouse 903, a magnetic disk drive 920, and controls these hardware devices.

Further, the CPU 911 can be connected to an FDD 904 (Flexible Disk Drive), a compact disk drive 905 (CDD), a printer device 906, or a scanner device 907. Or the magnetic disk drive 920 can be replaced with a memory device such as an optical disk drive, a memory card reading/writing device, etc.

The RAM 914 is an example of a volatile memory. Storage medium of the ROM 913, the CDD 905, and the magnetic disk drive 920 are examples of nonvolatile memories. These are examples of a memory device or a memory unit.

The communication board 915, the keyboard 902, the scanner device 907, the FDD 904, etc. are examples of an inputting unit or an inputting device.

Further, the communication board 915, the display unit 901, the printer device 906, etc. are examples of an outputting unit or an outputting device.

The communication board 915 can be connected via network to a log collection/management system which is a destination of transferring logs. For example, the communication board 915 can be connected to a LAN (local area network), the Internet, a WAN (wide area network), etc.

The magnetic disk drive 920 stores an operating system 921 (OS), a window system 922, a group of programs 923, and a group of files 924. Programs of the group of programs 923 are executed by the CPU 911, the operating system 921, and the window system 922.

Further, the magnetic disk drive 920 can store the log with signature shown in FIGS. 1 and 2.

The group of programs 923 store programs for executing functions that will be explained in the present and following embodiments as the log output processing unit 101 and its internal configuration. The programs are read and executed by the CPU 911.

The group of files 924 store information, data, signal values, variable values, or parameters showing a result of processing which will be discussed in the following explanation as “determination of--”, “calculation of--”, “comparison of--”, “evaluation of--”, “generation of--”, etc. as each item of “--file” or “-- database”. “-- file” or “-- database” are stored in the recording medium such as disks or memories. The information, data, signal values, variable values, or parameters stored in the storage medium such as disks or memories are read by the CPU 911 via a reading/writing circuit to a main memory or a cache memory, and used for the operation of the CPU such as extraction, retrieval, reference, comparison, operation, calculation, processing, compilation, output, printing, displaying, etc. During the operation of the CPU of extraction, retrieval, reference, comparison, operation, calculation, processing, compilation, output, printing, displaying, the information, data, signal values, variable values, or parameter are temporarily stored in the main memory, the register, the cache memory, the buffer memory, etc.

Further, an arrow part of the flowcharts which will be explained in the following mainly shows an input/output of data or signals, and the data or the signal values are recorded in the recording medium such as a memory of the RAM 914, a flexible disk of the FDD 904, a compact disk of the CDD 905, a magnetic disk of the magnetic disk drive 920, and others like an optical disk, a mini-disk, a DVD, etc. Further, the data or signals are transmitted on-line by the transmission medium such as the bus 912, a signal line, a cable, etc.

Further, the log output processing unit 101 and its internal configuration which will be explained in the present and following embodiments can be “-- circuit”, “-- device”, “-- equipment”, “-- means”, and also can be “-- step”, “-- procedure”, “-- process”.

Namely, the log output processing unit 101 and its internal configuration which will be explained can be implemented by firmware stored in the ROM 913. Or it can be implemented only by software, only by hardware such as elements, devices, boards, wiring, etc., or a combination of software and hardware, and further implemented by a combination with firmware. The firmware and software are stored as programs in the recording medium such as a magnetic disk, an flexible disk, an optical disk, a compact disk, a mini-disk, a DVD, etc.

The programs are read by the CPU 911, and executed by the CPU 911. Namely, the programs are to function the computer as the log output processing unit 101 and its internal configuration which will be discussed in the present and following embodiments. Or they are to have the computer execute the procedure and the method of the log output processing unit 101 and its internal configuration which will be discussed in the present and following embodiments.

Like this, the log output device 100 described in the present and following embodiments is a computer including the CPU being a processing device, the memory, the magnetic disk, etc. being a memory device, the keyboard, the mouse, the communication board, etc. being an inputting device, the display unit, the communication board, etc. being an outputting device, and as discussed above, functions shown as the log output processing unit 101 and its internal configuration are implemented by the processing device, the memory device, the inputting device, and the outputting device.

(Operation at the Time of Outputting a Log)

In the following, the operation at the time of outputting a log will be explained.

FIG. 5 is a flowchart showing an example of the operation (the data processing method) of the log output processing unit 101 at that time.

When the log output process starts, at step ST301, the hash value comparing unit 1011 of the log output processing unit 101 first reads the hash part 12 of the latest record of the disk 112, namely, the last hash part 12 appended to the last data stored in the disk 112 the last.

Next, at step ST302, the hash value comparing unit 1011 compares with a copy value of the last hash part 12 maintained on the latest hash memory unit 102 (the process memory).

At step ST303, if they are mismatched, the hash value comparing unit 1011 determines that the log on the disk is tampered, the tampering detecting report generating unit 1016 generates a tampering detecting report at step ST312, the data storing unit 1014 outputs the tampering detecting report to the disk 112, and the log output process terminates.

On the other hand, at step ST303, if the last hash part 12 and its copy are matched, the hash value generating unit 1012 calculates a data hash (DH) 13 from the data part 11 of the corresponding data at step ST304.

Next, at step ST305, the hash value generating unit 1012 calculates a link hash (LH) 14 from the copy of the last hash part 12 maintained on the latest hash memory unit 102 (the process memory), and at step ST306, the data hash and the link hash are combined to generate the hash part 12.

Then, at step ST307, the data storing unit 1014 generates the record 10 by combining the data part 11 and the hash part 12.

Here, at step ST308, the signature generating unit 1013 determines if a signature request from the signature requesting unit 103 exists or not, and if the signature request exists, the signature generating unit 1013 further calculates a signature 15 of the hash part 12 at step ST309, appends the signature 15 to the record 10, and on the other hand, does not do anything if no signature request exists.

As the above, the generated record is outputted by the data storing unit 1014 to the disk 112 at step ST310, at step ST311, the hash value copying and storing unit 1015 generates a copy of the hash part 12 generated at steps ST304-306, and that copy is maintained on the latest hash memory unit 102 (the process memory).

Up to above, the log output process terminates.

By operating as discussed above, it is possible to form a hash chain in the log outputted on the disk.

Further, if a block without protection by a signature is tampered, the tamper cannot be detected; however, as has been discussed above, by maintaining the hash part 12 (DH and LH combined) of the last record on the process memory, and making a comparison everytime writing the record on the disk, it is possible to detect tampering of the block without protection by the signature.

Further, by configuring to maintain on the tamper proof device 106 the copy of the hash part 12 maintained on the process memory, it is possible to prevent undetectable tampering with a higher precision. Namely, it is possible to prevent the hash part 12 of the last record on the disk and the hash maintained on the process memory from being simultaneously tampered.

Further, as shown in FIG. 7, if they are mismatched at step ST303, the tampering detecting report generating unit 1016 generates a tampering detecting report (step ST312), after the data storing unit 1014 outputs the tampering detecting report to the disk 112 (ST313), the hash value generating unit 1012 generates the data hash (DH) 13 from the data part 11 of the log output data (step ST314), and the hash value generating unit 1012 generates the link hash (LH) 14 from the data hash (DH) 13 (step ST315). By operating as above, new data can be separated from the tampered last data, so that a new hash chain can be formed from this new data.

Further, advantages of the configuration of the present embodiment will be explained by referring to the patent document 1.

In both of an idea discussed in the present embodiment and an idea of the patent document 1, the log on the disk can be divided into the data part 11 and the hash part 12; both of which can be a target to be tampered. Therefore, although both ideas provide a configuration to have a copy of the hash part 12 on a memory, according to the patent document 1, only a part corresponding to the data hash (DH) 13 in the configuration of the present embodiment is maintained on the memory, but a part corresponding to the link hash (LH) 14 is not maintained on the memory.

Instead, according to the patent document 1, by appending signatures to the records on the disk, undetectable tampering, which may be possibly done on the link hash part, is prevented. As long as such a configuration is kept, the signature must be appended to every record on the disk, which always causes a problem of signature processing load that has been explained at the beginning of this specification.

On the other hand, since the present embodiment is configured to maintain also the link hash (LH) 14 on the memory, it is unnecessary to rely on the signatures of all records on the disk for preventing undetectable tampering, which successfully generates a large effect that the signature can be partially done.

Like this, according to the present embodiment, the existence of tampering of the link hash is checked, and if no tampering exists on the link hash, it is possible to confirm the hash chain is correct.

(Operation at the Time of Appending Signatures)

Next, the operation at the time of appending signatures (the operation in case of appending a signature independently from the log output process) will be discussed.

FIG. 6 is a flowchart showing an operation example of the log output processing unit 101 at that time.

On starting the signature process, first at step ST401, the hash value comparing unit 1011 reads the latest record on the disk. Next, at step ST402, it is determined whether the read latest record has been signed or not, and if already signed, the process terminates, since the signature process is unnecessary.

If not signed, at step ST403, the hash value comparing unit 1011 compares the hash part 12 of the read record with the hash part 12 of the latest record maintained on the process memory.

At step ST404, if they are mismatched, the hash value comparing unit 1011 determines that the log record on the disk is tampered, and at step 407, the tampering detecting report generating unit 1016 generates a tampering detecting report, the data storing unit 1014 outputs the tampering detecting report to the disk, and the signature process terminates.

At step ST404, if matched, step ST405, the signature generating unit 1013 calculates a signature of the hash part 12.

Next, at step ST406, the signature generating unit 1013 appends the signature to the latest record on the disk, and the signature process terminates.

By the above configuration, it is possible to append a signature at an arbitrary timing when the log output processing unit 101 receives the signature request other than the timing for outputting the log to the disk.

(Signature Appendage at a Certain Number of Lines Interval)

Based on the configuration/operation discussed above, the signature generating unit 1013 of the log output processing unit 101 can append a signature to the log at a certain number of lines interval (a certain data interval).

Here, this can be implemented by the following: a number-of-record-outputs counter, not illustrated, is provided inside of the log output processing unit 101, when reaching a certain number of times, the counter itself outputs the signature request to the signature generating unit 1013, and the signature is appended to the record written on the disk. A predetermined number of lines interval is specified in a setting file, also not illustrated, and it is possible to configure the log output processing unit 101 so as to read the number at the time of starting.

By the above configuration, it is possible to reduce the processing load and the log size caused by the signature of the log, and further to output the log without undetectable tampering.

(Signature Appendage at a Certain Time Interval)

Based on the configuration/operation discussed above, the signature generating unit 1013 of the log output processing unit 101 can append a signature to the log at a certain time interval.

This can be implemented by the following: a timer, not illustrated, is provided inside of the log output processing unit 101, when a certain time period has passed after the previous signature is done, the timer itself outputs the signature request to the signature generating unit 1013, and the signature is appended to the latest record on the disk. A certain time interval is specified in a setting file, also not illustrated, and it is possible to configure the log output processing unit 101 so as to read the interval at the time of starting.

By the above configuration, it is possible to reduce the processing load and the log size caused by the signature of the log, and further to output the log without undetectable tampering.

(Integrity Verification of the Log (at Normal Operation))

FIG. 4 is a flowchart showing verification process of the log outputted in the format explained in FIG. 1 by log verifying means (a log verifying program mounted on a log collection/management system of a transferred destination of the log).

When the verification process starts, at step ST201, the latest record of the log (the last record of the log) is read.

At step ST202, it is determined if the last record is the signed record or not (normally, the latest record is the signed record when the log is verified), and if it is the signed record, the process proceeds to step ST206. The process will be discussed later when it is not the signed record.

At step ST206, the signature is decrypted using a public key of the log output device, and at step ST207, the decrypted signature is compared with the hash part 12 of the record.

If they are matched at step ST208, the process proceeds to step ST212. The process will be discussed later when they are mismatched.

In order to verify the data part 11, at step ST212, a hash of the data part 11 is calculated and it is compared with the data hash (DH) 13 of the hash part 12. If they are matched at step ST213, the process proceeds to ST215. The process will be discussed later when they are mismatched.

At step ST215, the previous record is read in order to verify a link to the previous record.

If no previous record exists at step ST216, the verification process terminates.

If the previous record exists at step ST216, the record which is currently read is set as an object of verification at step ST217, a hash of the hash part 12 of the verification object record is calculated, and the hash is compared with the link hash (LH) 14 of the hash part 12 of the previous verification object record. At step ST218, the match is confirmed again.

By repeating the above processes until it is determined that there is no record at step ST216, the verification of log can be performed.

(Integrity Verification of the Log (in Case the Latest Record is Not a Signed Record))

If it is determined that the latest record is not a signed record at step ST202, at step ST219, that record is determined to be untrustworthy.

Next, in order to search the latest signed record, the subsequent (the previous) record is read at step ST203.

At step ST204, the existence/absence of the record is checked, and if the record exists, the process returns back to step ST202 again to determine if it is the signed record or not. By repeating the above process, the latest signed record is searched.

During the process, if it is determined that no signed record exists at ST204, the log is determined to be unverifiable at step ST205, and the verification process terminates.

(Integrity Verification of the Log (In Case the Hash Part is Tampered))

At step ST208, if the hash part 12 is not matched with the decrypted signature or the link hash (LH) 14 of the previous verification object record, at step ST209, it is determined that all the records being older than the verification object record inclusive among the corresponding signature block are untrustworthy, and at step ST210, the log is searched up to next signature (block).

If it is determined that the signed record exists at step ST211, the verification process is continued again from that record at step ST206. If it is determined that no signed record exists, the verification process terminates.

(Integrity Verification of the Log (In Case the Data Part is Tampered))

At step ST213, if the hash of the data part 11 and the data hash (DH) 13 are mismatched, it is determined that the data part 11 of the corresponding record is tampered at step ST214, then the process returns to step ST215, and the verification process is continued again from the previous record.

Hereinbefore, in the present embodiment, the log output device has been explained, which forms, for data which is outputted along the time axis such as a log, a record including a data part corresponding to the data (message) body and a hash part to be newly appended and outputs to the disk.

Then, it has been explained that in the log output device, the hash part is formed by a hash of the data part (hereinafter, called as data hash “DH”) and a hash of the hash part of the previous record (hereinafter, called as link hash “LH”) (if no previous data exists, a hash of DH is LH), and a hash chain including a link of the hash part is formed.

Further, it has been explained that the log output device appends the signature only to a part of the records of the hash chain.

Further, it has been explained that the log output device, at timing when data is outputted, forms a record by calculating DH and LH of the corresponding data and generating a hash part, outputs it to the disk, and as well maintains a copy of the hash part generated (including both DH and LH) on the process memory.

Further, it has been explained that the log output device, when next data is outputted, compares the hash part of the latest record on the disk with the hash part maintained on the process memory, if they are matched, it is determined that the record on the disk is not tampered, further the record linked by the hash chain is outputted on the disk, if they are mismatched, it is determined that the record on the disk is tampered, detection of the tampering is recorded on the record, the next data is not linked to the previous record, and a new record is generated on the premise that there is no previous record.

Further, according to the present embodiment, the log output device has been explained, which maintains a copy of the hash part not on the process memory, but inside of a tamper proof device mounted on an equipment in which the program is operated.

Further, in the present embodiment, the log output device has been explained, which appends a signature to the hash part of the latest record on the disk at every certain number of lines interval of log record outputs.

Further, in the present embodiment, the log output device has been explained, which appends a signature to the hash part of the latest record on the disk at every certain time interval.

### Embodiment 2

(Signature Appendage Based on Application Instruction and Log Transfer Request from the Outside)

In the present embodiment, another embodiment will be discussed, in which timing for appending a signature to the log on the disk is at the time of instruction by the application 111 and at the time of log transfer request from the outside.

Here, configurations of the log output device, the log output processing unit 101, log format, etc. are the same as ones discussed in the first embodiment, and description is omitted in the present embodiment.

(Signature Appendage by Application Instruction)

Based on the configuration/operation explained in the first embodiment, the signature generating unit 1013 of the log output processing unit 101 can append signatures to the log at timing instructed by the application 111.

This can be implemented by configuring the device so that the application 111 requests the linked log output library 110 to output the log, and as well instructs the log output processing unit 101 to append a signature after the output at the same time. The instruction of signature request can be implemented by adding a parameter whose input is existence/absence of the signature request to a log output API (Application Programming Interface) provided by the log output library 110.

By this configuration, if one unit of processing in some business application is logically set as a log to be verified, for example, the application instructs to also append the signature when recording the end of the process in the log, then the signature can be appended to the last record of the logical log to be verified.

(Signature Appendage by Log Transfer Request from the Outside)

Based on the configuration/operation explained in the first embodiment, the signature requesting unit 103 of the log output processing unit 101 can append the signature to the log at timing when a log transfer request is issued from the outside (a log collection/management system, for example).

This can be implemented by configuring the device so that the signature requesting unit 103 receives a log transfer request from the outside log collection/management system, not illustrated.

The signature requesting unit 103 can be configured to receive the log transfer request as a signal.

By this operation, the log collection/management system can confirm the integrity of all the records, since the signature is appended to the last record of the log received from the log output device 100.

In the present embodiment, the log output device has been explained, which appends the signature to the hash part of the latest record on the disk at timing instructed by the application.

Further, in the present embodiment, the log output device has been explained, which appends the signature to the hash part of the latest record on the disk when the log transfer request is issued from the outside.

### Embodiment 3

### (Signature Appendage Based on Instruction of an Administrator or an Operator)

In this embodiment, another case will be explained, in which it is assumed a signature is appended to a log on a disk when an instruction is done by an administrator or an operator.

Here, the configuration of the log output device, the log output processing unit 101, the log format, etc. are the same as discussed in the first embodiment, and their descriptions will be omitted in this embodiment.

Based on the configuration/operation explained in the first embodiment, the signature requesting unit 103 of the log output processing unit 101 can append the signature to the log at timing when the signature request is issued from the administrator or the operator (a user of the log output device 100).

This can be implemented by configuring the device so that the signature requesting unit 103 receives the signature request from the administrator or the operator.

By this configuration, it is possible to obtain the log of which the integrity is verifiable for all the records at irregular timing when the administrator/operator thinks necessary other than periodical or routine log collection timing.

As discussed above, in the present embodiment, the log output device has been explained, which appends the signature to the hash part of the latest record on the disk at timing instructed by the administrator/operator.

### Embodiment 4

### (Signature Appendage Based on Timing When IDS/IPS Detects Intrusion)

In the present embodiment, another case will be explained, in which the signature is appended to the log on the disk at timing when an IDS (Intrusion Detection System) or an IPS (Intrusion Prevention System) attached to the log output device 100 detects the intrusion.

Here, the configurations of the log output device, the log output processing unit 101, the log format, etc. are the same as discussed in the first embodiment, and their descriptions will be omitted in this embodiment.

By configuring the device so that the intrusion detection event by the IDS/IPS is received by the signature requesting unit 103 of the log output device, the signature generating unit 1013 can generate the signature when the intrusion detection event occurs.

By this configuration, it is possible to append the signature to the log before the log output device is affected by threat of the security.

Like the above, in the present embodiment, the log output device has been explained, which appends the signature to the latest record on the disk at timing when the IDS (Intrusion Detection System)/the IPS (Intrusion Prevention System) detects the intrusion.

### Embodiment 5

### (Operation of the Log Output Processing Unit 101 at the Time of Starting/Finishing)

In the present embodiment, another embodiment of the operation will be discussed, which is carried out by the log output processing unit 101 for the log on the disk at the time of starting/finishing.

The log output device 100 related to the present embodiment has an internal configuration, for example, as shown in FIG. 8.

In FIG. 8, although including the same function as shown in the first embodiment, the signature generating unit 1013 generates the signature for data outputted the last when the log output processing unit 101 finishes the operation according to the present embodiment.

Then, when the log output processing unit 101 is started, a data checking unit 1017 checks the data stored in the disk 112, if there exists data stored after the last data to which the signature is appended, the data checking unit 1017 generates an alert to notify that there exists the data stored after the last data to which the signature is appended. This is because it is considered the data stored after the last data to which the signature is appended might have possibly been tampered.

In FIG. 8, elements other than the signature generating unit 1013 and the data checking unit 1017 are the same as shown in FIG. 3.

Further, the log format is the same as described in the first embodiment.

(Operation of the Log Output Processing Unit 101 at the Time of Finishing)

The signature generating unit 1013 of the log output processing unit 101 is configured to append the signature to the latest record on the disk 112 (the record which has been stored in the disk the last) at the time of finishing the operation (at the time of finishing the program if the log output processing unit 101 is configured by the program).

In UNIX (registered trademark), it is generally done that a SIGTERM signal is received at the time of finishing the process, so that the above can be concretely implemented by configuring to include this process in a SIGTERM signal handler.

By this configuration, it is possible to eliminate a case in which a record, which is not protected by the signature, remains on the disk.

(Operation of the Log Output Processing Unit 101 at the Time of Starting)

The data checking unit 1017 of the log output processing unit 101 is configured to refer to the latest log record on the disk 112 at the time of starting the log output processing unit 101 (at the time of starting the program if the log output processing unit 101 is configured by the program), and if the signature is not appended, to record an alert that the log record recorded after the last signature is untrustworthy (if no signed record exists in the log, the whole log is untrustworthy).

By this configuration, it is possible to prevent a case in which one trusts the log, which is tampered when no signature is appended.

Like the above, in the present embodiment, the log output device has been explained, which appends the signature to the last log record on the disk at the time of finishing the operation.

Further, in the present embodiment, the log output device has been explained, which records at the time of starting, if the signature is not appended to the last log record on the disk, that the record stored after the last signature is untrustworthy

### Embodiment 6

### (Narrowing the Possibly Tampered Position by Combination With a Hash Tree)

In the present embodiment, another form will be discussed, in which if the log on the disk is tampered, the possibly tampered position is narrowed as narrow as possible.

In the verification method of the log using the hash chain, as shown in the first embodiment or FIG. 4, if the hash part 12 of the record is tampered, the record older than the tampered record should be determined as untrustworthy even if it is not tampered, since the older record cannot be verified.

Therefore, the method can accomplish the first object of preventing the undetectable tampering; however, if the signature record or the hash part 12 of its adjacent record is tampered, the whole or most part of the log sometimes cannot be trusted.

In the present embodiment, a configuration will be explained, in which by linking the record using not only the hash chain but also a linking method called a hash tree, it is possible to narrow a possibly tampered range as narrow as possible if the log is tampered.

(Configuration of the Hash Tree)

FIG. 9 shows the signature block 2 including a plurality of log records with a hash tree implemented. Although the hash chain is simultaneously formed, only linked structure by the hash tree is shown in the figure, for the purpose of simplicity.

Data hash (DH1) 50 of the first stage is a hash of the data part 11 of each record. Further, data hash (DH2) 51 of the second stage is formed by hashing combined data of a certain number of pieces (three in the figure) of the data hash (DH1) 50 of the first stage.

Similarly, data hash (DH3) 52 of the third stage is formed by hashing combined data of a certain number of pieces (also three in the figure) of the data hash (DH2) 51 of the second stage.

Although FIG. 9 shows only up to the data hash of the third stage, it is needless to say that data hashes of the fourth stage or the fifth stage become necessary as the number of records increases.

Here, when appending the signature, it is configured to append the signature to a combination of a group of data hashes of the uppermost stage. Further, as the lower two records of the records shown in FIG. 9, if an incomplete number of records exist, whose number does not reach the certain number (three in the figure), it is configured so that a data hash of the one-upper stage is generated even if the number of records does not reach the certain number, and when the signature 60 is appended, the signature is appended after a hash covering the incomplete number of records is added, in addition to the group of data hashes of the uppermost stage.

The configuration of the log output device 100 of the present embodiment is the same as one shown in FIG. 2, and the configuration of the log output processing unit 101 is the same as one shown in FIG. 3.

In this embodiment, however, the hash value generating unit 1012 of the log output processing unit 101, as shown in FIG. 9, generates a data hash (DH) of the upper stage (upper level hash values) from a plurality of data hashes (DH) (the first hash value), generates a data hash of the further upper stage (further upper level hash values) from a plurality of data hashes of the upper stage, and generates data hashes (DH) of upper stages over a plurality of hierarchies.

Further, in the present embodiment, the signature generating unit 1013 of the log output processing unit 101 generates the signature using the data hash of the uppermost stage out of the data hashes (DH) of the upper stage generated by the hash value generating unit 1012.

(Verification of the Hash Tree)

Next, the verification of the hash tree generated by the above configuration will be explained.

First, the log collection/management system, which obtains the log from the log output device 100, decrypts the signature using the public key of the log output device 100, and compares with a combination of a group of hashes of the uppermost node. Namely, a combination of a group of data hashes of the uppermost stage and the data hash extracted from the decrypted signature are compared. If they are matched, the data hash of each uppermost node is compared with the hash of a combination of the group of hashes of the one lower stage. This kind of comparison is repeated up to the node of the lowermost stage, and if all are matched, it is possible to verify that the hash part has not been tampered.

Next, a hash of the data part 11 is calculated for each record, and by comparing with the data hash of the first stage, it is possible to detect the existence/absence of the tampering of the data part 11.

Here, if the tampering exists in the hash part, all data in the records hanging downwardly from the tampered node are considered to be untrustworthy.

For example, if the data hash of the third stage placed uppermost in FIG. 9 is correct (if the data hash of the third stage is matched with the data hash extracted from the decrypted signature) and it is not matched with a hash of a combination of the group of its data hashes of the second stage, the subsequent data (9 records from the top in FIG. 9) is considered to be untrustworthy.

(Effect by Combining the Hash Chain and the Hash Tree)

The following will explain effect obtained from combining the hash chain and the hash tree.

Using only the hash chain, as has been discussed above, there is a problem that if the hash part 12 of the signature record or its adjacent record is tampered, a large part of the records become untrustworthy; in such a case, if the hash part of the hash tree (the hash part of the hash tree is DH1, DH2, and DH3) is not tampered, it is possible to verify all records. In the contrary case (although a part of the hash part of the hash tree is tampered, the hash part of the hash chain (the hash part of the hash chain is DH1 and LH) is not tampered), it is also possible to verify all records.

Further, even if the hash part of the hash tree and the hash part of the hash chain are tampered at the same time, when the tampered position is at the lower stage of the tree, there remains a large verifiable range, which enables to obtain effect that it is possible to make a part, which is unverifiable by the hash chain, verifiable.

As above, in the present embodiment, the log output device has been explained, which outputs the records to the disk with linking the hash parts hierarchically in addition to the hash chain, and appends the signature to the group of hashes of the uppermost node of the tree at timing of the signature.

Here, the log output device 100 and the log output processing unit 101 shown in the first through sixth embodiments are effective for the use which aims the securement of log integrity required at, for example, a contents distribution system or a company information system, with practical processing load and data amount.

Here, although in the foregoing first through sixth embodiments, the log output device has been explained using the log data as an example, the log output device shown in the first through sixth embodiments can be applied to not only the log data but also data which is sequentially outputted.

### BRIEF EXPLANATION OF THE DRAWINGS

FIG. 1 is a block diagram showing a format of a log outputted by a log output device according to the first through fifth embodiments.

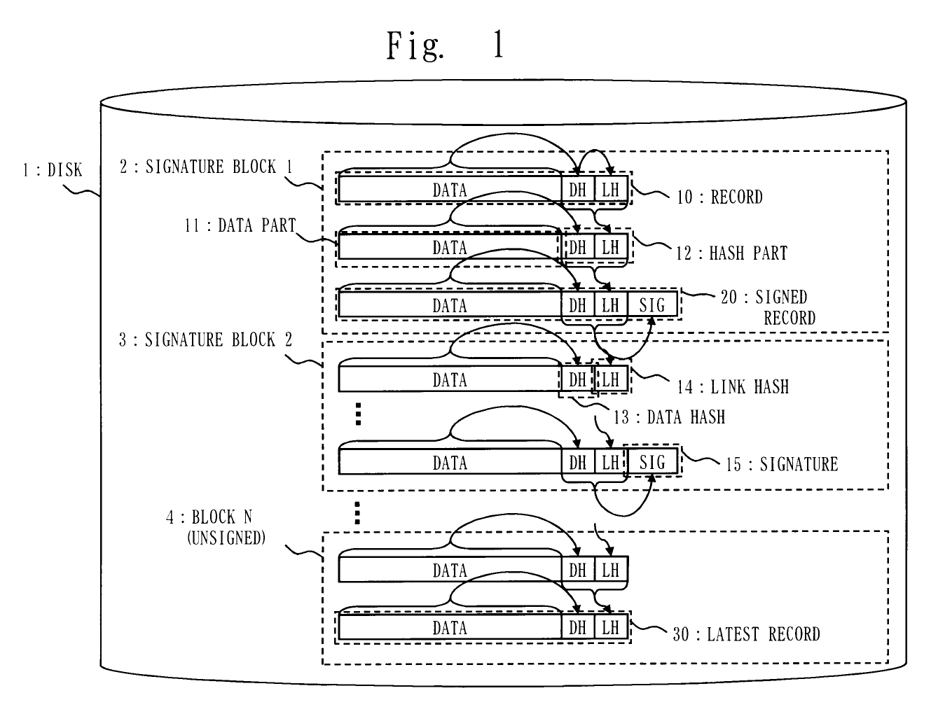

FIG. 2 is a block diagram showing a configuration example of the log output device according to the first through fifth embodiments.

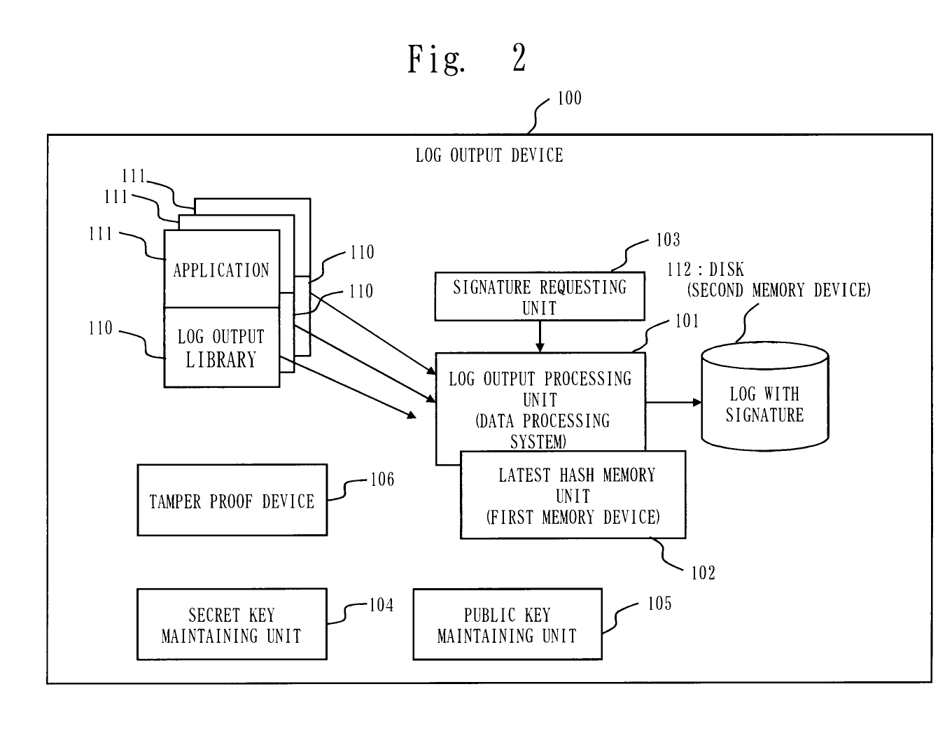

FIG. 3 is a block diagram showing an internal configuration example of a log output device according to the first through fifth embodiments.

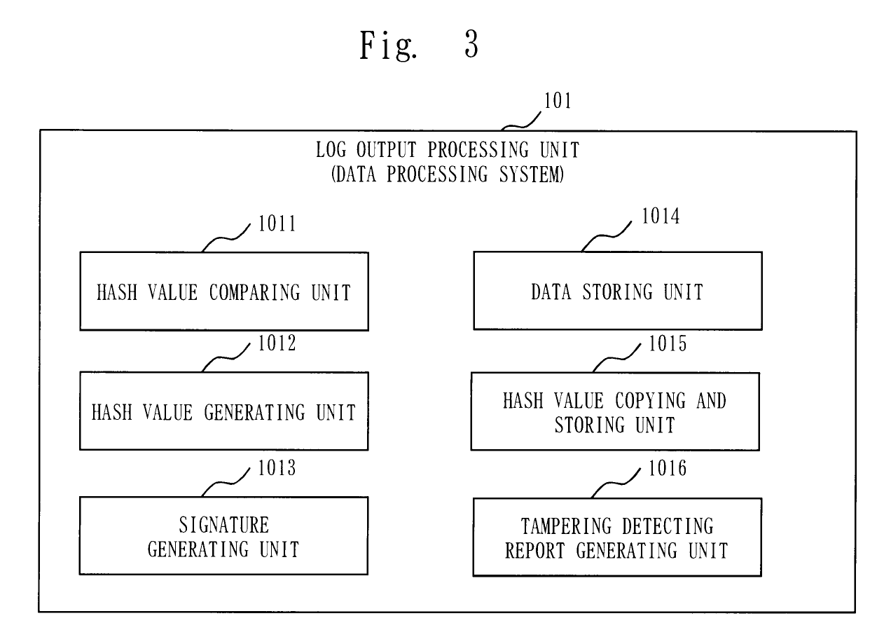

FIG. 4 is a flowchart for verifying the integrity of the log outputted in the format of FIG. 1.

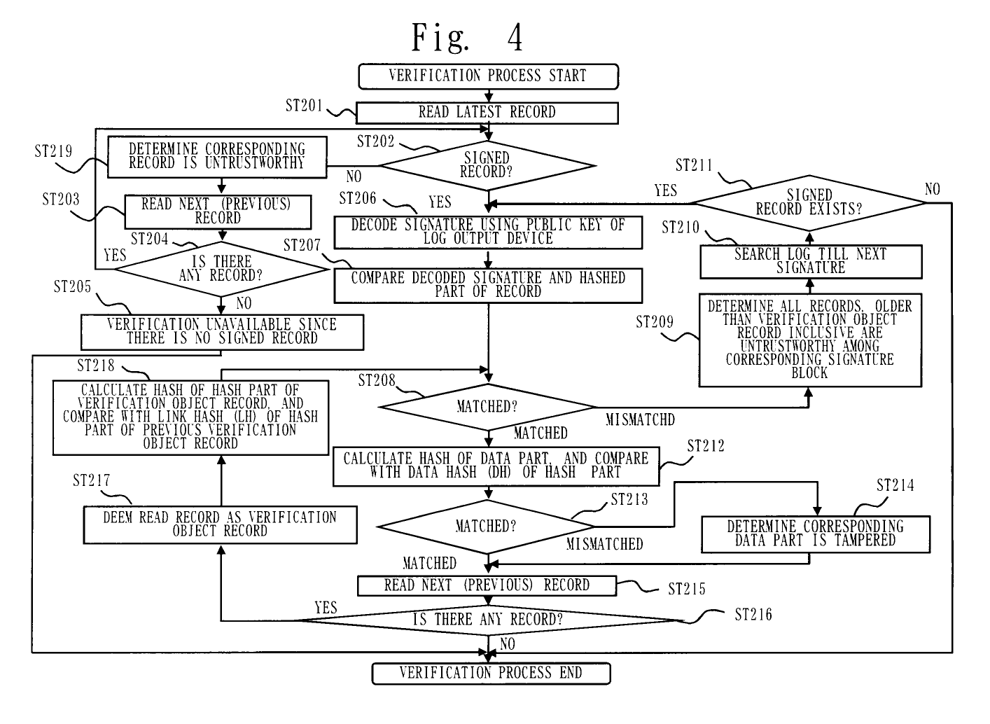

FIG. 5 is a flowchart showing an operation example of the log output processing unit 101 at the time of outputting the log according to the first embodiment.

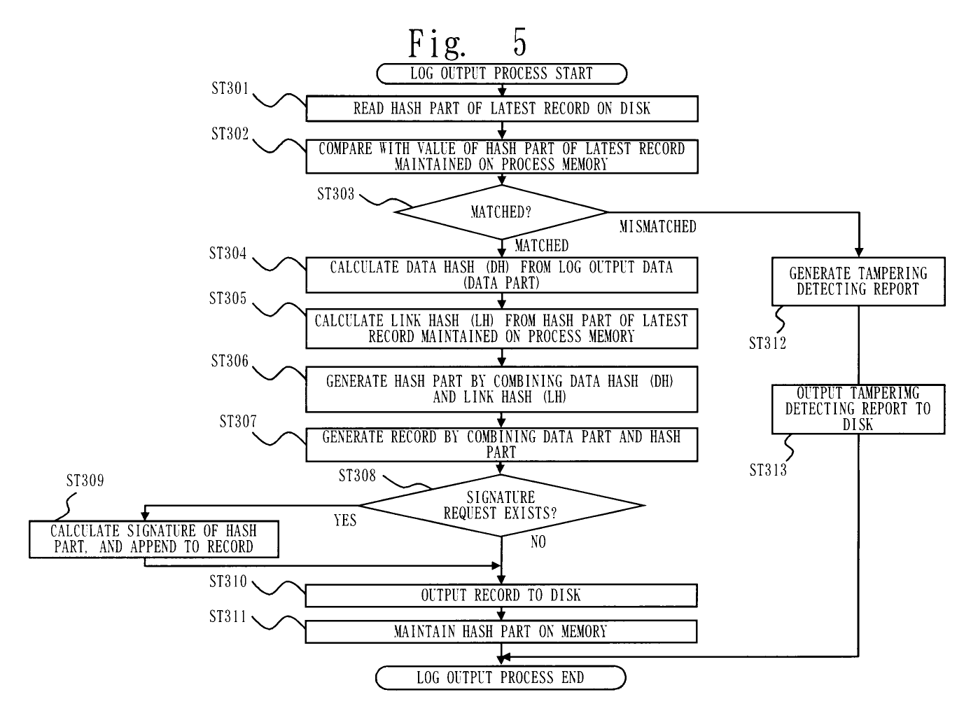

FIG. 6 is a flowchart showing an operation example of the log output processing unit 101 at the time of appending the signature according to the first embodiment.

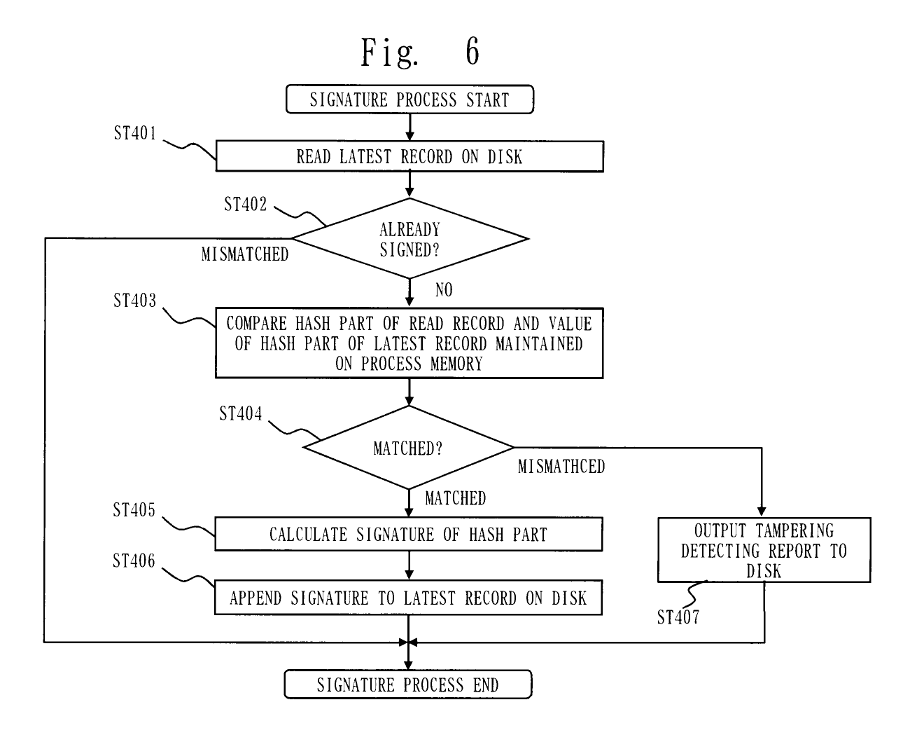

FIG. 7 is a flowchart showing an operation example of the log output processing unit 101 at the time of outputting the log according to the first embodiment.

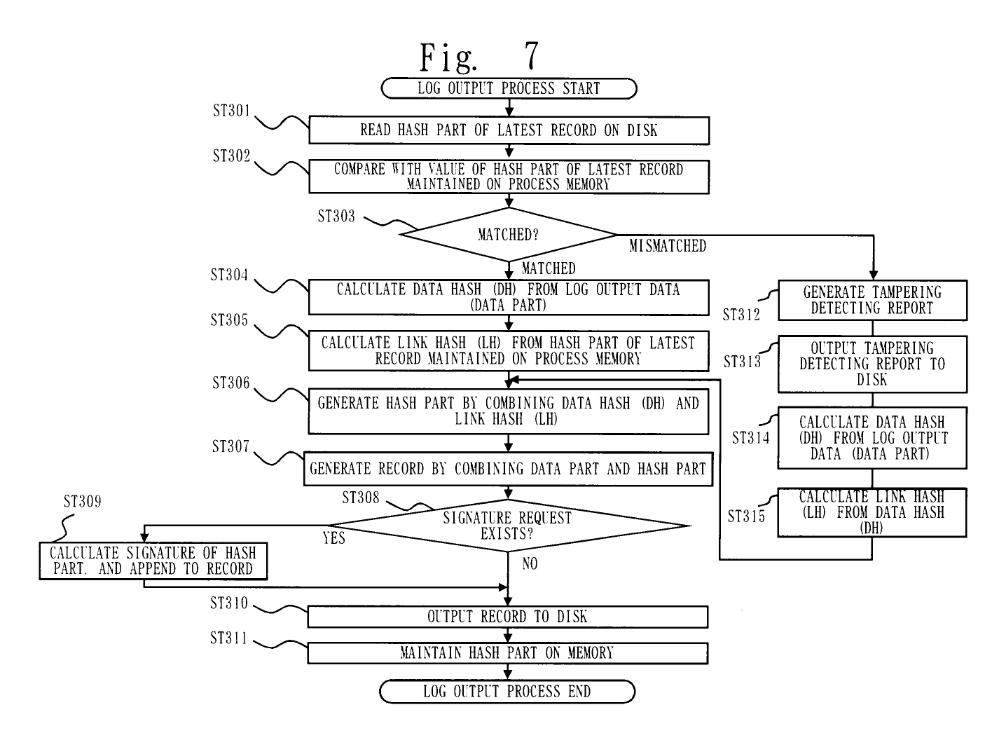

FIG. 8 shows an internal configuration example of a log output processing unit according to the fifth embodiment of the invention.

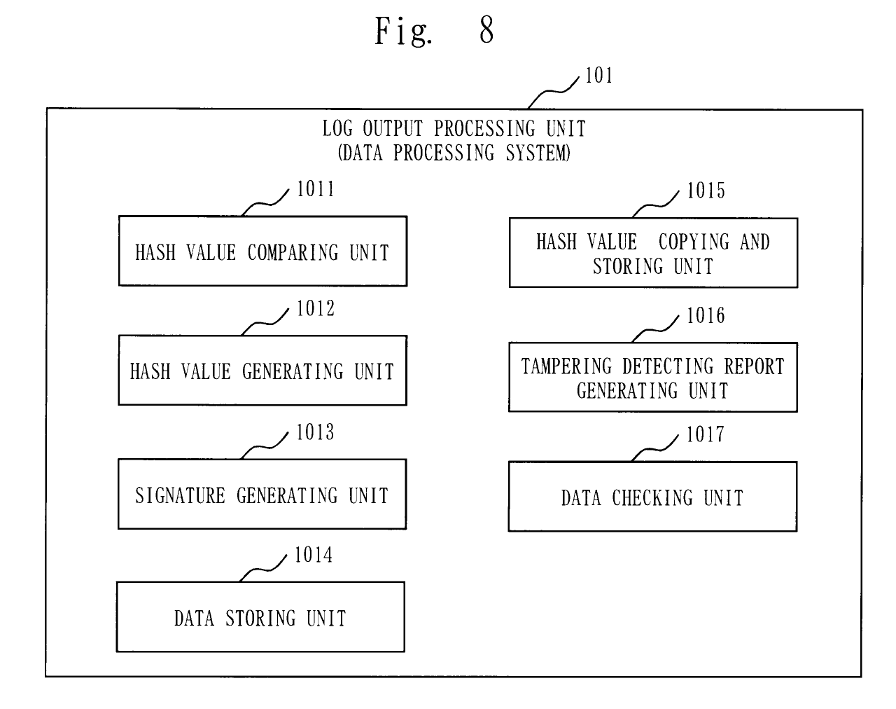

FIG. 9 shows a format of the log outputted by the log output device according to the sixth embodiment.

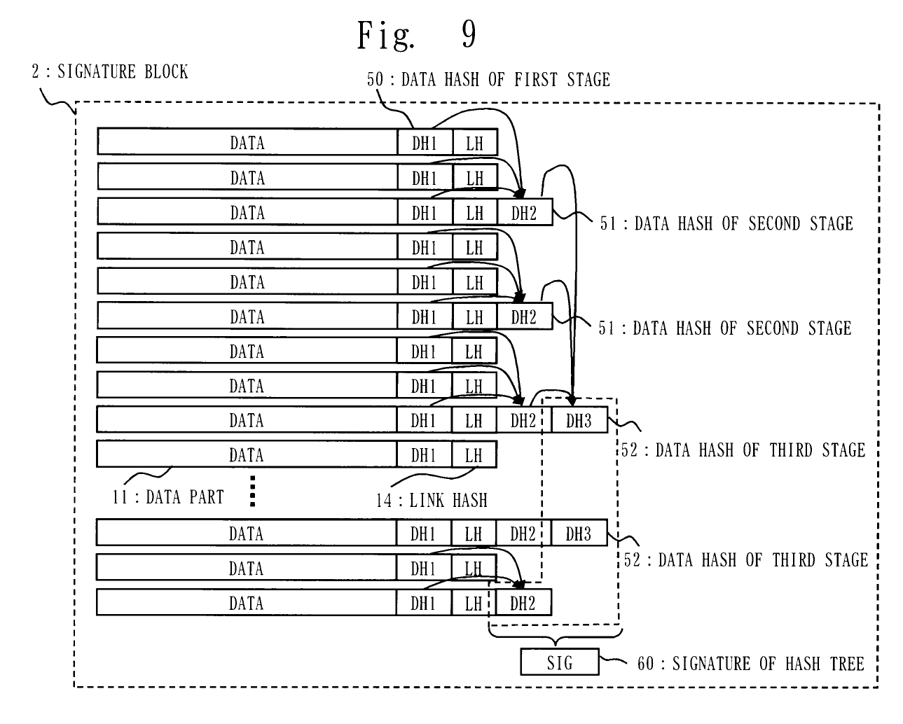

FIG. 10 shows a hardware configuration example of the log output device according to the first through sixth embodiments.

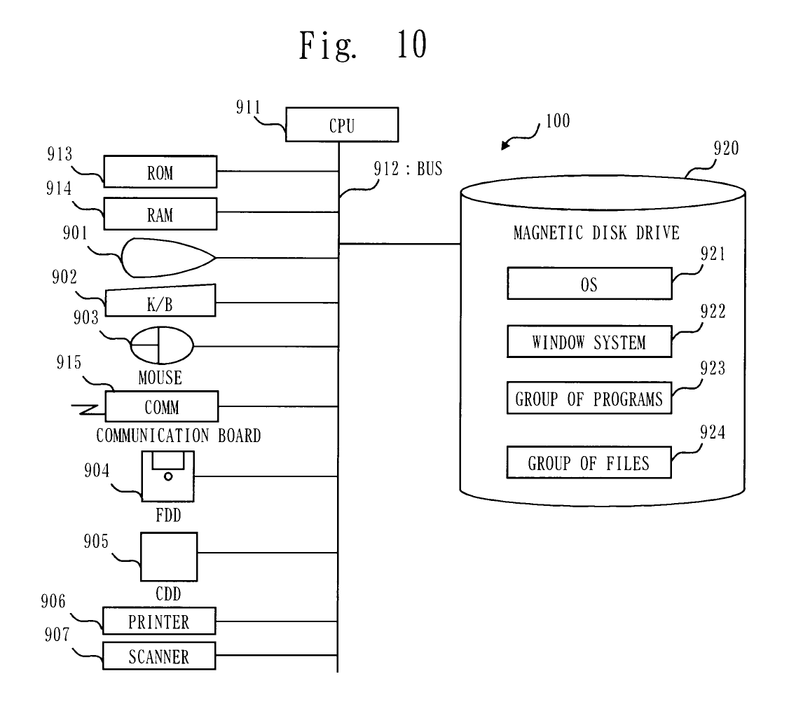

### EXPLANATION OF SIGNS

100: a log output device, 101: a log output processing unit, 102: a latest hash memory unit, 103: a signature requesting unit, 104: a secret key maintaining unit, 105: a public key maintaining unit, 106: a tamper proof device, 110: a log output library, 111: an application, 1011: a hash value comparing unit, 1012: a hash value generating unit, 1013: a signature generating unit, 1014: a data storing unit, 1015: a hash value copying and storing unit, 1016: a tampering detecting report generating unit, and 1017: a data checking unit.

1. A data processing system using a first memory device and a second memory device, appending a hash value to data which is sequentially outputted, and storing the data to which the hash value is appended in the second memory device, the data processing system comprising:
a hash value copying and storing unit, at each time of storing the data in the second memory device, for copying a first hash value and a second hash value which are appended to storage data to be stored in the second memory device, the first hash value being generated from the storage data, the second hash value being generated from a hash value of data which has been stored prior to the storage data, and storing a copy of the first hash value and the second hash value in the first memory device;
a hash value comparing unit, when new data is outputted, for comparing a last first hash value and a last second hash value appended to last data stored last in the second memory unit with a copy of the last first hash value and the last second hash value stored in the first memory device;
a hash value generating unit, when the hash value comparing unit determines that the last first hash value and the last second hash value and the copy of the last first hash value and the last second hash value are matched, for generating a new first hash value from the new data, and generating a new second hash value from the last first hash value and the last second hash value; and
a data storing unit for appending the new first hash value and the new second hash value generated by the hash value generating unit to the new data, and storing the new data to which the new first hash value and the new second hash value are appended in the second memory device.

2. The data processing system of claim 1,
wherein the hash value generating unit, when the hash value comparing unit determines that the last first hash value and the last second hash value and the copy of the last first hash value and the last second hash value are mismatched, generates the new first hash value from the new data, and generates the new second hash value from a value other than the last first hash value and the last second hash value.

3. The data processing system of claim 1 further comprising:
a tampering detecting report generating unit, when the hash value comparing unit determines that the last first hash value and the last second hash value and the copy of the last first hash value and the last second hash value are mismatched, for generating a tampering detecting report to notify of a tampering in the last data.

4. The data processing system of claim 1,
wherein the hash value copying and storing unit stores the copy of the first hash value and the second hash value in a tamper proof device as the first memory device.

5. The data processing system of claim I further comprising:
a signature generating unit for generating a signature for a specific piece of data among a plurality pieces of data, and appending the signature generated to only the specific piece of data.

6. The data processing system of claim 5,
wherein the signature generating unit generates the signature at every certain interval of data.

7. The data processing system of claim 5,
wherein the signature generating unit generates the signature at every certain interval of time.

8. The data processing system of claim 5,
wherein the signature generating unit generates the signature based on an instruction from an application program which uses the data processing system.

9. The data processing system of claim 5,
wherein the signature generating unit generates the signature when a transfer request of data stored in the second memory device is issued from outside of the data processing system.

10. The data processing system of claim 5,
wherein the signature generating unit generates the signature based on an instruction from a user who uses the data processing system.

11. The data processing system of claim 5,
wherein the signature generating unit generates the signature when an IDS (Intrusion Detection System)/IPS (Intrusion Prevention System) of the data processing system detects unauthorized intrusion.

12. The data processing system of claim 5,
wherein the signature generating unit generates the signature for data outputted last, when the data processing system finishes operation.

13. The data processing system of claim 12 further comprising:
a data checking unit, when the data processing system starts, for checking data stored in the second memory device, and if there exists data stored after last data to which a signature is appended, generating an alert to notify of existence of the data stored after the last data to which the signature is appended.

14. The data processing system of claim 1,
wherein the hash value generating unit generates upper level hash values from a plurality of first hash values, generates further upper level hash values from a plurality of upper level hash values, and generates upper level hash values over a plurality of hierarchies.

15. The data processing system of claim 14 further comprising:
a signature generating unit for generating a signature using a hash value of an uppermost level among upper level hash values generated by the hash value generating unit.

16. A data processing method using a first memory device and a second memory device, appending a hash value to data which is sequentially outputted, and storing the data to which the hash value is appended in the second memory device, the method comprising:
at each time of storing the data in the second memory device, copying a first hash value and a second hash value which are appended to storage data to be stored in the second memory device, the first hash value being generated from the storage data, the second hash value being generated from a hash value of data which has been stored prior to the storage data, and storing a copy of the first hash value and the second hash value in the first memory device;
when new data is outputted, comparing a last first hash value and a last second hash value appended to last data stored last in the second memory unit with a copy of the last first hash value and the last second hash value stored in the first memory device;
when it is determined that the last first hash value and the last second hash value and the copy of the last first hash value and the last second hash value are matched, for generating a new first hash value from the new data, and generating a new second hash value from the last first hash value and the last second hash value; and
appending the new first hash value and the new second hash value generated to the new data, and storing the new data to which the new first hash value and the new second hash value are appended in the second memory device.

17. A program for making a computer having a first memory device and a second memory device append a hash value to data which is sequentially outputted, and store the data to which the hash value is appended in the second memory device, the program making the computer execute:
a hash value copying and storing process, at each time of storing the data in the second memory device, for copying a first hash value and a second hash value which are appended to storage data to be stored in the second memory device, the first hash value being generated from the storage data, the second hash value being generated from a hash value of data which has been stored prior to the storage data, and storing a copy of the first hash value and the second hash value in the first memory device;
a hash values comparing process, when new data is outputted, for comparing a last first hash value and a last second hash value appended to last data stored last in the second memory unit with a copy of the last first hash value and the last second hash value stored in the first memory device;
a hash value generating process, when the hash value comparing process determines that the last first hash value and the last second hash value and the copy of the last first hash value and the last second hash value are matched, for generating a new first hash value from the new data, and generating a new second hash value from the last first hash value and the last second hash value; and
a data storing process for appending the new first hash value and the new second hash value generated by the hash value generating process to the new data, and storing the new data to which the new first hash value and the new second hash value are appended in the second memory device.
